(19) United States
(12) Patent Application Publication
(10) Pub. No.: US 2025/0239608 A1
(43) Pub. Date: Jul. 24, 2025

(54) HIGH THERMAL STABILITY AND LOW COST BATTERY CELLS

(71) Applicant: GM GLOBAL TECHNOLOGY OPERATIONS LLC, Detroit, MI (US)

(72) Inventors: Dewen KONG, Shanghai (CN); Jingyuan LIU, Shanghai (CN); Haijing LIU, Shanghai (CN); Fan XU, Oakland Township, MI (US); Mei CAI, Bloomfield Hills, MI (US)

(21) Appl. No.: 18/598,132

(22) Filed: Mar. 7, 2024

(30) Foreign Application Priority Data
Jan. 23, 2024 (CN) 202410097536.3

(51) Int. Cl. H01M 4/58; H01M 4/02; H01M 4/36; H01M 4/48; H01M 4/587

(52) U.S. Cl. CPC H01M 4/5825; H01M 4/366; H01M 4/48; H01M 4/587; H01M 2004/021

(57) ABSTRACT

A battery cell includes C cathode electrodes each including a cathode active material layer arranged on a cathode current collector. The cathode active material layer comprises a cathode active material including LiMnₓFe_{1-x-y}MyPO₄, where x and y are less than one and M includes one or more metal dopants. A anode electrodes each including an anode active material layer arranged on an anode current collector. The anode active material layer comprises an anode active material including graphite and at least one of lithium silicon oxide (LSO) and silicon-carbon (Si—C) and S separators, where C, A and S are integers greater than one.

### CROSS-REFERENCE TO RELATED APPLICATIONS

This application claims the benefit of Chinese Patent Application No. 202410097536.3, filed on Jan. 23, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells comprising cathode electrodes including LiMnₓFe_{1-x-y}M_{y}PO₄ and anode electrodes comprising graphite and lithium silicon oxide (LSO) or silicon-carbon (Si—C).

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes each including a cathode active material layer arranged on a cathode current collector. The cathode active material layer comprises a cathode active material including LiMnₓFe_{1-x-y}MyPO₄, where x and y are less than one and M includes one or more metal dopants. A anode electrodes each including an anode active material layer arranged on an anode current collector. The anode active material layer comprises an anode active material including graphite and at least one of lithium silicon oxide (LSO) and silicon-carbon (Si—C) and S separators, where C, A and S are integers greater than one.

In other features, the one or more metal dopants are selected from a group consisting of titanium (Ti), magnesium (Mg), aluminum (Al), calcium (Ca), niobium (Nb), cobalt (Co), and yttrium (Y) and tungsten (W). The cathode active material includes a carbon coating.

In other features, the cathode active material layer comprises 90 wt % to 97 wt % of the cathode active material, 1 wt % to 5 wt % of a conductive additive, and 1 wt % to 5 wt % of a binder.

In other features, the anode active material layer comprises the LSO, and the LSO comprises Li_{y}SiOₓ where 0<x<2 and 0<y<1.

In other features, the anode active material layer comprises the LSO, the LSO comprises 10 wt % to 30 wt % of the anode active material, and the graphite comprises 70 wt % to 90 wt % of the graphite. A D50 particle size of the at least one of the LSO and the Si—C is in a range from 3 μm to 20 μm.

In other features, the anode active material layer comprises 90 wt % to 97 wt % of the LSO and the graphite, 1 wt % to 5 wt % of a binder, and 1 wt % to 5 wt % of a conductive additive. The cathode active material comprises LiMn_{0.7}Fe_{0.26} Nb_{0.02}Y_{0.01}Mg_{0.01}PO₄.

In other features, capacity loading of the cathode active material layer is in a range from 3 to 7 mAh/cm². Capacity loading of the anode active material layer is in a range from 3.3 to 7.7 mAh/cm².

A battery cell includes C cathode electrodes each including a cathode active material layer arranged on a cathode current collector. The cathode active material layer comprises a cathode active material including LiMnₓFe_{1-x-y}M_{y}PO₄ where x and y are less than one and M includes one or more metal dopants selected from a group consisting of titanium (Ti), magnesium (Mg), aluminum (AI), calcium (Ca), niobium (Nb), cobalt (Co), and yttrium (Y), and tungsten (W). A anode electrodes each include an anode active material layer arranged on an anode current collector. The anode active material layer comprises anode active material including graphite and lithium silicon oxide (LSO) and S separators, where C, A and S are integers greater than one.

In other features, the cathode active material includes a carbon coating. The cathode active material layer comprises 90 wt % to 97 wt % of the cathode active material, 1 wt % to 5 wt % of a conductive additive, and 1 wt % to 5 wt % of a binder.

In other features, the anode active material layer comprises the LSO, and the LSO comprises Li_{y}SiOₓ where 0<x<2 and 0<y<1.

In other features, the anode active material layer comprises the LSO, the LSO comprises 10 wt % to 30 wt % of the anode active material, and the graphite comprises 70 wt % to 90 wt % of the graphite. A D50 particle size of the LSO is in a range from 3 μm to 20 μm.

In other features, the anode active material layer comprises 90 wt % to 97 wt % of the LSO and the graphite, 1 wt % to 5 wt % of a binder, and 1 wt % to 5 wt % of a conductive additive. The cathode active material comprises LiMn_{0.7}Fe_{0.26}Nb_{0.02}Y_{0.01}Mg_{0.01}PO₄.

In other features, capacity loading of the cathode active material layer is in a range from 3 to 7 mAh/cm². Capacity loading of the anode active material layer is in a range from 3.3 to 7.7 mAh/cm².

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of a battery cell including cathode electrodes including LiMnₓFe_{1-x-y}M_{y}PO₄, anode electrodes including LSO or SiC, and separators according to the present disclosure;

FIG. 2 is a side cross section a cathode electrode comprising a cathode active material layer including LiMnₓFe_{1-x-y}M_{y}PO₄ according to the present disclosure;

FIG. 3 is a side cross section of an anode electrode comprising an anode active material layer including LSO or Si—C according to the present disclosure;

FIG. 4 is a graph illustrating differential scanning calorimetry (DSC) (heat flow as a function of temperature) for a lithium nickel cobalt manganese aluminum oxide (NCMA) electrode and an LMFP battery cell according to the present disclosure;

FIG. 5 is a graph illustrating voltage as a function of specific capacity for a battery cell according to the present disclosure;

FIG. 6 is a graph illustrating SOC as a function of time for a battery cell according to the present disclosure; and

FIG. 7 is a graph illustrating voltage as a function of discharge ratio vs. C/3 for a battery cell according to the present disclosure;

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Battery cells including nickel-rich cathode active material are too expensive and thermal unstable. The cost of the battery cells is high due to the use of both nickel and cobalt and insufficient moisture control during manufacturing. The Ni-rich cathode active material decomposes at temperatures below 300° C. and generates molecular oxygen O₂. The oxygen that is released reacts with flammable cell components includes the electrolyte solvents and separators and causes thermal instability and/or thermal runaway events.

The present disclosure relates to a high thermal stability and low-cost lithium-ion battery cell including cathode electrodes with LiMnₓFe_{1-x-y}M_{y}PO₄ (e.g., LiMn_{0.7}Fe_{0.26}Nb_{0.02}Y_{0.01}Mg_{0.01}PO₄) as the cathode active material and anode electrodes including graphite and lithiated silicon oxide (LSO) or silicon-carbon (Si—C). The battery cells described herein are cobalt- and nickel-free and are substantially lower cost as compared to commercial Ni-rich cathode battery cells (e.g., ˜40% lower). The battery cells have good cycling performance, high thermal stability, enhanced safety, and high-rate performance.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. In some examples, the cathode active material layers 24 and/or the anode active material layers 42 comprise coatings including one or more active materials, one or more conductive additives, and/or one or more binder materials that are cast or applied onto the current collectors. During charging/discharging, the A anode electrodes 40 and the C cathode electrodes 20 exchange lithium ions.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells. The battery cells can be stacked or wound. The enclosure can comprise a prismatic enclosure, a pouch enclosure, or a cylindrical enclosure. The battery cell format can be stacked or wound.

Referring now to FIG. 2, one of the C cathode electrodes 20 is shown in further detail. The cathode active material layer 24 of the C cathode electrodes 20 includes cathode active material 62, a conductive additive 64, and a binder 66. In some examples, the cathode active material 62 includes LiMnₓFe_{1-x-y}M_{y}PO₄ (e.g., LiMn_{0.7}Fe_{0.26}Nb_{0.02}Y_{0.01}Mg_{0.01}PO₄), where M includes one or more metal dopants. In some examples, the metal dopants are selected from a group consisting of titanium (Ti), magnesium (Mg), aluminum (AI), calcium (Ca), niobium (Nb), cobalt (Co), and yttrium (Y) and tungsten (W).

In some examples, the cathode active material includes a carbon coating. In some examples, the carbon coating comprises 1 to 5 wt %. In some examples, carbon coating comprises 1.5 wt % to 2.0 wt %. In some examples, Brunauer, Emmett, and Teller (BET) of the cathode active material layer is in a range from 4 m²/g to 30 m²/g. In some examples, tap density (TD) of the cathode active material layer is in a range from 0.5 to 2 g/cc. In some examples, tap density (TD) of the cathode active material layer is in a range from 0.6 to 0.9 g/cc. In some examples, pH of the cathode active material layer is in a range from 8 to 11 (10 wt. % dispersion).

In some examples, a wet roll-to-roll manufacturing process is used. The cathode active material is mixed with a conductive additive, a binder, and a solvent and cast onto a cathode current collector. In some examples, the cathode active material layer comprises 90 wt % to 97 wt % of the cathode active material, 1 wt % to 5 wt % of the conductive additive, and 1 wt % to 5 wt % of the binder. In some examples, the conductive additive includes one or more materials selected from a group consisting of Super P, KS-6, graphite, graphene, and carbon nanotubes (single or multi-walled).

In some examples, capacity loading of the cathode active material layer is in a range from 3 to 7 mAh/cm² (for single-sided coating, 0.1C at room temperature). In some examples, pressing density of the cathode active material layer is in a range from 1.5 to 2.5 g/cm³. The porosity of the cathode active material layer is in a range from 20 to 43%. In some examples, moisture content of the cathode active material layer is less than 600 ppm at 180° C.

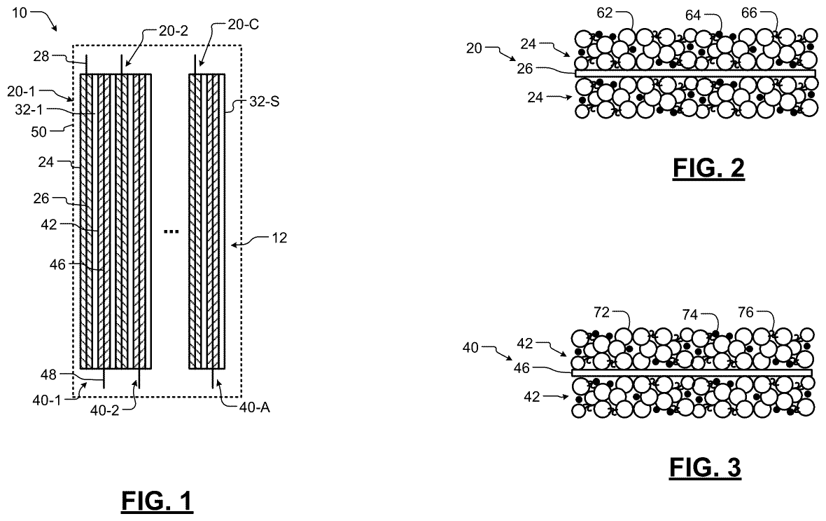

Referring now to FIG. 3, one of the A anode electrode 40 is shown in further detail. The anode active material layer 42 of the anode electrode 40 includes anode active material 72, a conductive additive 74, and a binder 76.

In some examples, the anode active material comprises graphite and LSO (or Si—C). In some examples, the LSO comprises chemically lithiated silicon oxide (SiOₓ). In some examples, the graphite has a D50 particle size in a range from 6 μm to 20 μm. Brunauer, Emmet, and Teller (BET) of the anode active material layer is in a range from 1 m²/g to 10 m²/g. In some examples, the graphite comprises 70 wt % to 90 wt % of the anode active material layer. In some examples, tap density (TD) of the anode active material layer is in a range from 0.5 g/cc to 1.5 g/cc.

In some examples, the LSO comprises Li_{y}SiOₓ (0<x<2 and 0<y<1). In some examples, the LSO comprises 10 wt % to 30 wt % of the anode active material layer. D50 particle size of the LSO (or Si—C) is in a range from 3 μm to 20 μm. BET of the anode active material layer is in a range from 0.5 m² to 10 m². TD of the anode active material layer is in a range from 0.8 g/cc to 1.5 g/cc.

In some examples, the anode active material layer includes 90 wt % to 97 wt % of the LSO (or Si—C) and graphite, 1 wt % to 6 wt % of the binder, and 1 wt % to 6 wt % of the conductive additive. In some examples, the conductive additives are selected from a group consisting of Super P, graphite, graphene nanoplates, single-walled carbon nanotubes, multi-walled carbon nanotubes, and combinations thereof. In some examples, the binder is selected from a group consisting of styrene butadiene (SBR), carboxymethyl cellulose (CMC), and polyacrylic acid (PAA). In some examples, a combination of SBR and CMC, CMC and SBR and PAA, CM and PAA, or pure PAA can be used. In some examples, the mass ratio of the LSO is greater than or equal to 10 wt. %.

In some examples, the anode active material layer has a capacity loading in a range from 3.3 to 7.7 mAh/cm² (for one side coating, 0.1C at room temperature) The anode active material layer has a pressing density in a range from 1.3 to 1.9 g/cm³. The anode active material layer has a porosity in a range from 20% to 38%. The anode active material layer has a moisture content that is less than 500 ppm.

In some examples, the separators have a thickness in a range from 10 μm to 30 μm and a porosity in a range from 35% to 55%. In some examples, the separator includes a ceramic layer and a polymer coating layer. In some examples, the thickness of polymer coated layer is in a range from 1 μm to 5 μm. In some examples, the thickness of polymer coated layer is in a range from 1 μm to 3 μm. If a coated separator is used, the separator can be a double-sided coated separator with the same or different coating layers.

In some examples, the electrolyte comprises lithium salt such as LiPF₆ in a range from 0.8 to 1.2 mol/L in a solvent such as carbonate ester. In some examples, the electrolyte further comprises one or more additives selected from a group consisting of fluoroethylene carbonate (FEC), vinylene carbonate (VC), 1,3,2-dioxathiolane-2,2-dioxide (DTD), tris (trimethylsilyl) phosphite (TMSPi), lithium bis (oxalato) borate (LiBOB), lithium bis(fluorosulfonyl) imide (LiFSI), lithium difluoro (oxalato) borate (LiDFOB), and trimethylsulfonium lead triiodide (TMSPB).

In some examples, the binder for the cathode active material layer comprises polyvinylidene difluoride (PVDF), polytetrafluoroethylene (PTFE), and/or polytetrafluoroethylene-hexafluoropropylene (PVDF-HFP) in non-aqueous solvent. In some examples, the anode binders comprise polyacrylic acid (PAA), poly (acrylic acid sodium) (NaPAA), lithium substituted polyacrylic acid (LiPAA), and/or CMC/SBR in aqueous solvent.

In some examples, an N/P ratio is in a range from 1 to 1.2 and an operating voltage in a range from 2V to 4.5V.

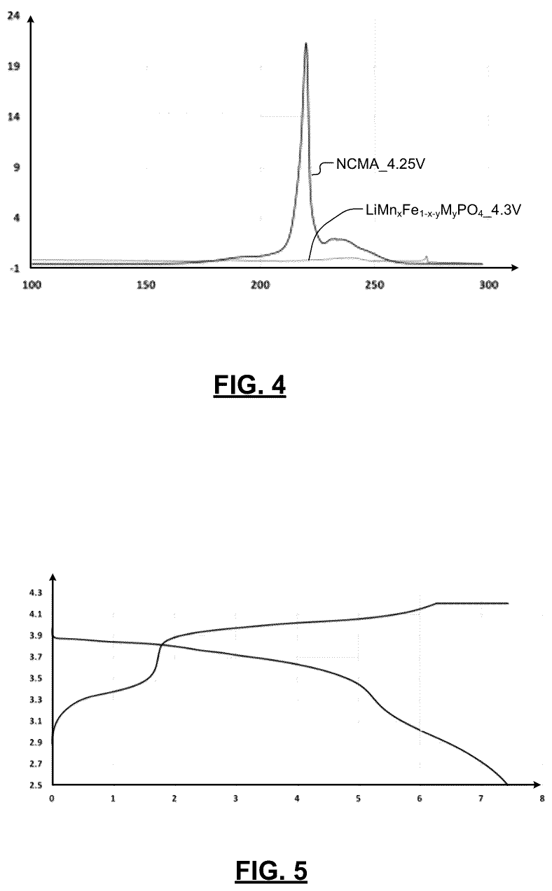

Referring now to FIGS. 4 and 5, the cathode electrodes have outstanding thermal stability. In FIG. 4, differential scanning calorimetry (DSC) is performed on a NCMA battery cell and an LMFP battery cell according to the present disclosure. During DSC testing, the difference in the amount of heat required to increase the temperature of a sample and a reference is measured as a function of temperature. The DSC test was performed at 100% SOC. The battery cells were heated at 5° C./minute to 300° C. The heat flow of the NMCA electrode spiked at about 210° C. In contrast, the electrode according to the present disclosure experienced little increased heat flow at the elevated temperatures.

In FIG. 5, performance of a pouch battery cell during C/3 continuous current continuous voltage (CCCV) charging and C/3 discharging at 25° C. is shown. The cathode active material includes LiMn_{0.7}Fe_{0.27}Mg_{0.03}PO₄ (5 mAh/cm²). The anode active material includes 30 wt % LSO and 70 wt % graphite (5.5 mAh/cm²). The operating voltage range is 2.5V to 4.2V.

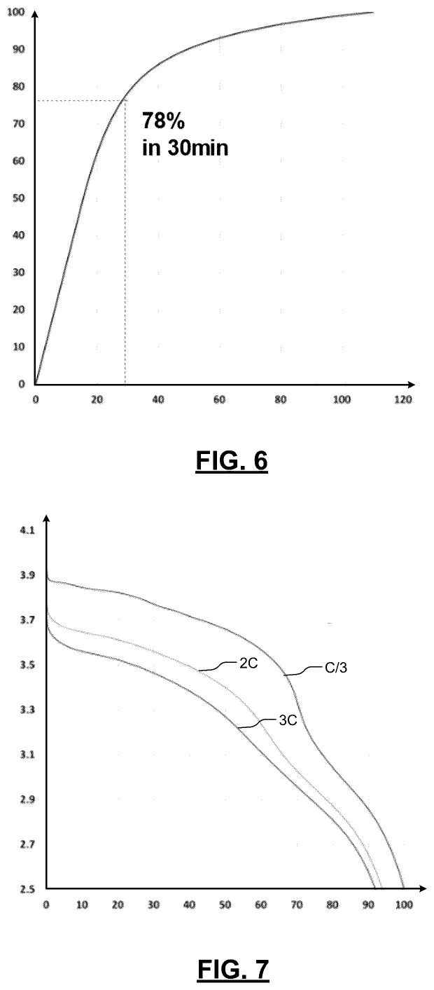

Referring now to FIGS. 6 and 7, the battery cell according to the present disclosure have improved fast charge capability and excellent discharge rate capability. In FIG. 6, the battery cell can be charged to 78% SOC within 30 minutes at a 2C charge rate at 25° C. (the SOC % is normalized to C/3 continuous current and continuous voltage CCCV). In FIG. 7, the battery cell according to the present disclosure has a 3C/0.33C discharge capacity greater than 90%. The battery cell also have excellent life cycle performance. Discharge capacity retention is greater than 99.8% after 100 cycles.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
C cathode electrodes each including a cathode active material layer arranged on a cathode current collector,
wherein the cathode active material layer comprises a cathode active material including LiMnₓFe_{1-x-y}M_{y}PO₄, where x and y are less than one and M includes one or more metal dopants;
A anode electrodes each including an anode active material layer arranged on an anode current collector,
wherein the anode active material layer comprises an anode active material including graphite and at least one of lithium silicon oxide (LSO) and silicon-carbon (Si—C); and
S separators, where C, A and S are integers greater than one.

2. The battery cell of claim 1, wherein the one or more metal dopants are selected from a group consisting of titanium (Ti), magnesium (Mg), aluminum (Al), calcium (Ca), niobium (Nb), cobalt (Co), and yttrium (Y) and tungsten (W).

3. The battery cell of claim 1, wherein the cathode active material includes a carbon coating.

4. The battery cell of claim 1, wherein the cathode active material layer comprises:
90 wt % to 97 wt % of the cathode active material,
1 wt % to 5 wt % of a conductive additive, and
1 wt % to 5 wt % of a binder.

5. The battery cell of claim 1, wherein:
the anode active material layer comprises the LSO, and
the LSO comprises Li_{y}SiOₓ where 0<x<2 and 0<y<1.

6. The battery cell of claim 1, wherein:
the anode active material layer comprises the LSO,
the LSO comprises 10 wt % to 30 wt % of the anode active material, and
the graphite comprises 70 wt % to 90 wt % of the graphite.

7. The battery cell of claim 1, wherein a D50 particle size of the at least one of the LSO and the Si—C is in a range from 3 μm to 20 μm.

8. The battery cell of claim 1, wherein the anode active material layer comprises:
90 wt % to 97 wt % of the LSO and the graphite,
1 wt % to 5 wt % of a binder, and
1 wt % to 5 wt % of a conductive additive.

9. The battery cell of claim 1, wherein the cathode active material comprises LiMn_{0.7}Fe_{0.26} Nb_{0.02}Y_{0.01}Mg_{0.01}PO₄.

10. The battery cell of claim 1, wherein:
capacity loading of the cathode active material layer is in a range from 3 to 7 mAh/cm²; and
capacity loading of the anode active material layer is in a range from 3.3 to 7.7 mAh/cm².

11. A battery cell comprising:
C cathode electrodes each including a cathode active material layer arranged on a cathode current collector,
wherein the cathode active material layer comprises a cathode active material including LiMnₓFe_{1-x-y}M_{y}PO₄ where x and y are less than one and M includes one or more metal dopants selected from a group consisting of titanium (Ti), magnesium (Mg), aluminum (AI), calcium (Ca), niobium (Nb), cobalt (Co), and yttrium (Y), and tungsten (W);
A anode electrodes each including an anode active material layer arranged on an anode current collector,
wherein the anode active material layer comprises anode active material including graphite and lithium silicon oxide (LSO); and
S separators, where C, A and S are integers greater than one.

12. The battery cell of claim 11, wherein the cathode active material includes a carbon coating.

13. The battery cell of claim 11, wherein the cathode active material layer comprises 90 wt % to 97 wt % of the cathode active material, 1 wt % to 5 wt % of a conductive additive, and 1 wt % to 5 wt % of a binder.

14. The battery cell of claim 11, wherein:
the anode active material layer comprises the LSO, and
the LSO comprises Li_{y}SiOₓ where 0<x<2 and 0<y<1.

15. The battery cell of claim 11, wherein:
the anode active material layer comprises the LSO,
the LSO comprises 10 wt % to 30 wt % of the anode active material, and
the graphite comprises 70 wt % to 90 wt % of the graphite.

16. The battery cell of claim 11, wherein a D50 particle size of the LSO is in a range from 3 μm to 20 μm.

17. The battery cell of claim 11, wherein the anode active material layer comprises:
90 wt % to 97 wt % of the LSO and the graphite,
1 wt % to 5 wt % of a binder, and
1 wt % to 5 wt % of a conductive additive.

18. The battery cell of claim 11, wherein the cathode active material comprises LiMn_{0.7}Fe_{0.26}Nb_{0.02}Y_{0.01}Mg_{0.01}PO₄.

19. The battery cell of claim 11, wherein:
capacity loading of the cathode active material layer is in a range from 3 to 7 mAh/cm²; and
capacity loading of the anode active material layer is in a range from 3.3 to 7.7 mAh/cm².
